(19) United States
(12) Patent Application Publication
(10) Pub. No.: US 2022/0314233 A1
(43) Pub. Date: Oct. 6, 2022

(54) UNDERGROUND COAL HYPERGRAVITY FIELD SEPARATION SYSTEM AND SEPARATION PROCESS

(71) Applicant: China University of Mining and Technology, Xuzhou (CN)

(72) Inventors: Enhui Zhou, Xuzhou (CN); Yuemin Zhao, Xuzhou (CN); Liang Dong, Xuzhou (CN); Chenlong Duan, Xuzhou (CN); Yongxin Ren, Xuzhou (CN); Nan Zhou, Xuzhou (CN)

(73) Assignee: China University of Mining and Technology, Xuzhou (CN)

(21) Appl. No.: 17/657,004

(22) Filed: Mar. 29, 2022

(30) Foreign Application Priority Data
Mar. 30, 2021 (CN) 202110342891.9

(51) Int. Cl. B03B 9/00; B03B 5/34; B03B 5/44; B03B 7/00; B03B 13/00

(52) U.S. Cl. CPC B03B 9/005; B03B 5/34; B03B 5/447; B03B 7/00; B03B 13/005

(57) ABSTRACT

The present disclosure relates to the field of mineral processing and separation, and in particular, to an underground coal hypergravity field separation system and a separation process. The separation system includes a grading hydrocyclone group, hypergravity field separators, feeding pumps, and conveying pumps. Coal collected underground is graded through a grading hydrocyclone first, then is fed into the hypergravity field separators for separation, and finally, is conveyed to a next link for dehydration through the conveying pumps. The separation system of the present disclosure has less supporting equipment, small floor area, and no complex pipeline, and is suitable for a downhole operation. In addition, the hypergravity field separators can provide a high-strength centrifugal acceleration, which can realize rapid separation of coal gangue particles in a radial direction and a tangential direction, and realize effective separation of fine coal gangue particles.

### CROSS REFERENCE TO RELATED APPLICATIONS

This application claims priority to Chinese Patent Application No. 202110342891.9, filed Mar. 30, 2021, the content of which is incorporated herein by reference in its entirety.

### TECHNICAL FIELD

The present disclosure relates to the field of mineral processing and separation, and in particular, to an underground coal hypergravity field separation system and a separation process.

### BACKGROUND ART

With the continuous development of a fully mechanized mining technology, the content of fine fraction in raw coal is increasing and the content of the raw coal<6 mm can reach 60%. Meanwhile, a large amount of gangue in a working face fault, a coal seam roof, and a floor is mixed into run-of-mine coal, while the run-of-mine coal is generally not treated underground. It is transported aboveground by a mine hoisting and transportation system, and then gangue discharge and separation operations are performed. This makes the gangue in coal flow occupies specified output of the raw coal in a mine when the run-of-mine coal is lifted up a mine, which results in a large amount of invalid transportation and greatly reduces the actual production capacity of the mine. Unnecessary energy consumption and a large amount of water consumption and medium consumption will be caused in subsequent treatment of the gangue, which wastes manpower and material resources and increases the enterprise cost. Therefore, there is an urgent need to develop an underground coal separation technology, so that the gangue is discharged underground and is backfilled on site.

A principle of the underground coal separation technology is consistent with that of aboveground coal separation. The difference is that a coal separation process system should be simplified, an equipment structure is optimized, and the floor area and the space height of equipment are minimized on the premise of meeting the separation precision and efficiency under the limitation of the height and the narrow space of an underground roadway. In actual industrial production at present, the application of a wet coal separation technology occupies a dominant position. The commonly used wet coal separation technologies mainly include jigging separation, heavy medium separation, Teeter Bed Separator (TBS) separation, etc.

Jigging separation equipment mainly adopts an air pulsating jig and a movable-sieve jig. The former one has a large separation particle size range and can realize the separation of 150 to 0.5 mm, but the separation precision is relatively low, which is only suitable for the separation of easy-to-separate coal or medium optional coal. The later one has the separation particle size range of 25-300 mm, and the lower limit of the separation particle size is high, which is mainly used for pre-discharging gangue from lump coal but cannot realize effective separation of fine particle coal.

The heavy medium separation is mainly divided into shallow groove separation and heavy medium cyclone separation. A shallow groove separator has a simple structure and large processing capacity, the effective separation particle size range is 13 to 300 mm, and the separation precision is higher than that of jigging separation. However, its floor space is large, a chain scraper is easy to wear, and the raw coal<6 mm cannot be effectively separated. The lower limit of the effective particle size of the heavy medium cyclone separation is 0.5 mm. However, as a heavy medium separation process, a medium purification and recovery process must be matched, which increases the floor area of the system and increases the cost investment of coal separation of an enterprise.

A TBS has a simple and relatively compact equipment structure, small floor space, no need of power, low energy consumption, and low coal separation cost, which is mainly used for coarse coal slime separation. The separation particle size range is 3 to 0.5 mm, and the separation precision is affected by the particle size ratio of feeding particles. When the ratio of the maximum particle size to the minimum particle size of a feeding material is about 4, the separation effect is better, but it is very difficult to control the particle size ratio of the feeding particles to be maintained at about 4.

### SUMMARY

An underground coal hypergravity field separation system includes a grading hydrocyclone group, conveying pumps, feeding pumps, and at least two hypergravity field separators.

The grading hydrocyclone group includes a feeding pipe, an overflow port, and an underflow port. The hypergravity field separator includes a floating object discharging port and a sediment discharging port.

The feeding pipe of the hypergravity field separator is connected to a raw coal conveying pipe. The overflow port and the underflow port of the grading hydrocyclone group are respectively connected to feeding ports of the two hypergravity field separators through the feeding pumps. The floating object discharging ports of the two hypergravity field separators are respectively connected to clean coal conveying pipes through the conveying pumps. The sediment discharging ports of the two hypergravity field separators are connected to gangue conveying pipes through the conveying pumps.

Further, the hypergravity field separator includes a rotating drum. A rotor is arranged at a bottom end inside the rotating drum. A floating object discharging port is formed in an upper part of the rotating drum. A sediment discharging port is formed in a lower part of the rotating drum.

Furthermore, the rotor is used to provide a centrifugal acceleration of 300 times the gravitational acceleration for a material entering the rotating drum.

A coal separation process based on the underground coal hypergravity field separation system includes the following steps:

s1, raw coal screening and breaking: adopting a 6 mm screening standard for raw coal, conveying an undersized product<6 mm to a grading hydrocyclone group, conveying an oversized product≥6 mm to a crushing machine, crushing the oversized product into particles less than 6 mm, and returning the particles to a screening process;

s2, raw coal grading: conveying the raw coal<6 mm to the grading hydrocyclone group through a feeding pipe, taking 1 mm as a grading standard, discharging coarse particles of 1-6 mm from an underflow port of the grading hydrocyclone group, conveying the particles to a hypergravity field separator corresponding to the underflow port, discharging a fine particle product<1 mm from an overflow port of the grading hydrocyclone group, and conveying the fine particle product to a hypergravity field separator corresponding to the overflow port;

s3: raw coal separation: feeding the raw coal<1 mm into a rotating drum of the hypergravity field separator corresponding to the overflow port of the grading hydrocyclone group at a certain pressure along a tangential direction through a feeding pump, and feeding the raw coal of 1-6 mm into the rotating drum of the hypergravity field separator corresponding to the underflow port of the grading hydrocyclone group at a certain pressure along a tangential direction through a feeding pump, so that a material forms descending spiral flow along an inner wall at an upper part of the rotating drum, and medium-density and high-density materials descend along outer spiral flow under the action of a centrifugal force to form upward inner spiral flow at an axis of the rotating drum due to a negative pressure, where the low-density material ascends along the inner spiral flow and is discharged through a floating object discharging port, the medium-density and high-density materials are accelerated by a high-speed rotor when descending to the bottom of the rotating drum along the outer spiral flow, the high-density material continues going downward along the inner wall under an action of an additional strong centrifugal force in a hypergravity field and is discharged through a sediment discharging port, and the medium-density material goes upward along the inner spiral flow and is discharged through a floating object discharging port; and

s4, product dehydration: respectively conveying clean coal and gangue obtained by separation to dehydration treatment.

The present disclosure has the following beneficial effects.

The separation system of the present disclosure has less supporting equipment, small floor area, and no complex pipeline, and is suitable for a downhole operation. In addition, the hypergravity field separators can provide a high-strength centrifugal acceleration, which can realize rapid separation of coal gangue particles in a radial direction and a tangential direction, and realize effective separation of fine coal gangue particles.

### BRIEF DESCRIPTION OF THE DRAWINGS

FIG. 1 is a schematic structural diagram of an underground coal hypergravity field separation system.

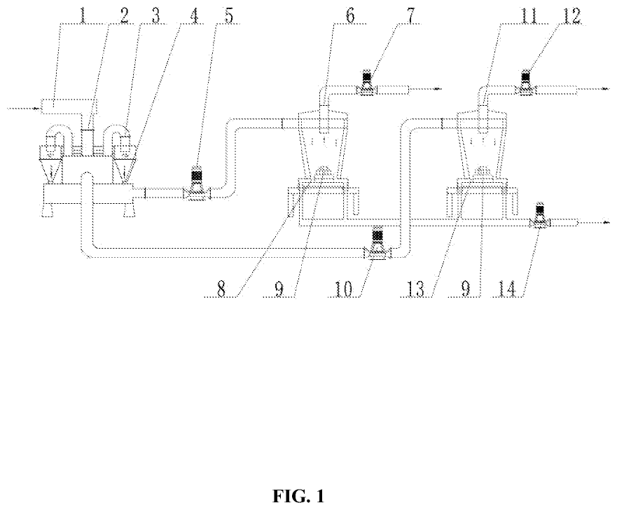

FIG. 2 is a flowchart of an underground coal hypergravity field separation process.

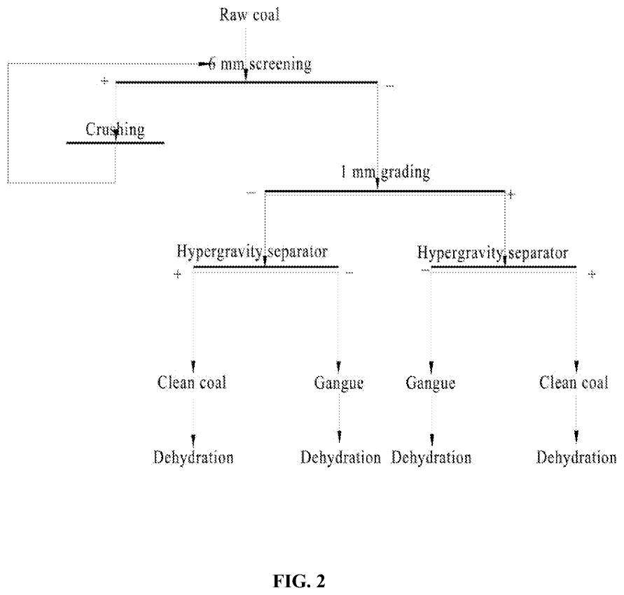

1—raw coal conveying pipe, 2—feeding pipe, 3—overflow port, 4—underflow port, 5—first feeding pump, 6—first floating object discharging port, 7—first conveying pump, 8—first sediment discharging port, 9—rotor, 10—second feeding pump, 11—second floating object discharging port, 12—second conveying pump, 13—second sediment discharging port, and 140—third conveying pump.

### DETAILED DESCRIPTION OF THE EMBODIMENTS

### Embodiment 1

An underground coal hypergravity field separation system includes a separation unit, a grading unit, and a conveying unit. The separation unit includes a first hypergravity field separator and a second hypergravity field separator. The grading unit includes a grading hydrocyclone group. The conveying unit includes a first feeding pump 5, a second feeding pump 10, a first conveying pump 7, a second conveying pump 12, and a third conveying pump 14.

A feeding pipe 2 of the grading hydrocyclone group is connected to a raw coal conveying pipe 1. An overflow port 3 of the grading hydrocyclone group is connected to a feeding port of the second feeding pump 10. An underflow port 4 of the grading hydrocyclone group is connected to a feeding port of the first feeding pump 5. A discharging port of the first feeding pump 5 is connected to a feeding pipe of the first hypergravity field separator. A first floating object discharging port 6 of the first hypergravity field separator is connected to a feeding port of the first conveying pump 7. A first sediment discharging port 8 of the first hypergravity field separator is connected to a feeding port of the third conveying pump 14.

A discharging port of the second feeding pump 10 is connected to a feeding pipe of the second hypergravity field separator. A second floating object discharging port 11 of the second hypergravity field separator is connected to a feeding port of the second conveying pump 12. A second sediment discharging port 13 of the second hypergravity field separator is connected to a feeding port of the third conveying pump 14.

Both a discharging port of the first conveying pump 7 and a discharging port of the second conveying pump 12 are connected to a clean coal conveying pipe. A discharging port of the third conveying pump 14 is connected to a gangue conveying pipe.

The hypergravity field separator includes a rotating drum. A rotor is arranged at a bottom end inside the rotating drum. The rotor is used to provide a centrifugal acceleration of 300 times the gravitational acceleration for a material entering the rotating drum. A floating object discharging port is formed in an upper part of the rotating drum. A sediment discharging port is formed in a lower part of the rotating drum.

A coal separation process based on the underground coal hypergravity field separation system includes the following steps:

s1, raw coal screening and breaking: raw coal adopts a 6 mm screening standard, an undersized product<6 mm is conveyed to a grading hydrocyclone group, an oversized product≥6 mm is conveyed to a crushing machine and is crushed into particles less than 6 mm, and the particles are returned to a screening process.

s2, raw coal grading: the raw coal<6 mm is conveyed to the grading hydrocyclone group through a feeding pipe; 1 mm is taken as a grading standard, coarse particles of 1-6 mm are discharged from an underflow port 4 of the grading hydrocyclone group and are conveyed to a first hypergravity field separator; and a fine particle product<1 mm is discharged from an overflow port 3 of the grading hydrocyclone group and is conveyed to a second hypergravity field separator.

s3: raw coal separation: the raw coal<1 mm is fed into a rotating drum of the second hypergravity field separator at a certain pressure along a tangential direction through a second feeding pump 10, and the raw coal of 1-6 mm is fed into the rotating drum of the first hypergravity field separator at a certain pressure along a tangential direction through a first feeding pump 5, so that a material forms descending spiral flow along an inner wall at an upper part of the rotating drum, and medium-density and high-density materials descend along outer spiral flow under the action of a centrifugal force to form upward inner spiral flow at an axis of the rotating drum due to a negative pressure, where the low-density material ascends along the inner spiral flow and is discharged through a floating object discharging port, the medium-density and high-density materials are accelerated by a high-speed rotor when descending to the bottom of the rotating drum along the outer spiral flow, the high-density material continues going downward along the inner wall under an action of an additional strong centrifugal force in a hypergravity field and is discharged through a sediment discharging port, and the medium-density material goes upward along the inner spiral flow and is discharged through a floating object discharging port.

s4, product dehydration: clean coal and gangue obtained by separation are respectively conveyed to dehydration treatment.

The embodiments described above are only description of preferred embodiments of the present disclosure, and do not limit the scope of the present disclosure. Various deformations and improvements made to the technical solution of the present disclosure by those of ordinary skill in the art without departing from the design spirit of the present disclosure shall fall within the protection scope determined by the claims of the present disclosure.

What is claimed is:

1. An underground coal hypergravity field separation system comprising a grading hydrocyclone group, conveying pumps, feeding pumps, and at least two hypergravity field separators, wherein:
the grading hydrocyclone group comprises a feeding pipe, an overflow port, and an underflow port;
the hypergravity field separator comprises a floating object discharging port and a sediment discharging port;
the feeding pipe of the hypergravity field separator is connected to a raw coal conveying pipe;
the overflow port and the underflow port of the grading hydrocyclone group are respectively connected to feeding ports of the two hypergravity field separators through feeding pumps;
the floating object discharging ports of the two hypergravity field separators are respectively connected to clean coal conveying pipes through the conveying pumps; and
the sediment discharging ports of the two hypergravity field separators are connected to gangue conveying pipes through the conveying pumps.

2. The underground coal hypergravity field separation system according to claim 1, wherein:
the hypergravity field separator comprises a rotating drum;
a rotor is arranged at a bottom end inside the rotating drum;
a floating object discharging port is formed in an upper part of the rotating drum; and
a sediment discharging port is formed in a lower part of the rotating drum.

3. The underground coal hypergravity field separation system according to claim 2, wherein the rotor is used to provide a centrifugal acceleration of 300 times the gravitational acceleration for a material entering the rotating drum.

4. A coal separation process based on the underground coal hypergravity field separation system, comprising the following steps:
raw coal screening and breaking, the raw coal screening and breaking comprising:
adopting a 6 mm screening standard for raw coal; conveying an undersized product smaller than 6 mm to a grading hydrocyclone group;
conveying an oversized product greater than or equal to 6 mm to a crushing machine;
crushing the oversized product into particles smaller than 6 mm; and
returning the particles to a screening process;
raw coal grading comprising:
conveying the raw coal smaller than 6 mm to the grading hydrocyclone group;
taking 1 mm as a grading standard;
discharging coarse particles of 1-6 mm from an underflow port of the grading hydrocyclone group;
conveying the particles to a hypergravity field separator corresponding to the underflow port;
discharging a fine particle product smaller than 1 mm from an overflow port of the grading hydrocyclone group; and
conveying the particles to a hypergravity field separator corresponding to the overflow port;
raw coal separation comprising:
feeding the raw coal smaller than 1 mm into a rotating drum of the hypergravity field separator corresponding to the overflow port of the grading hydrocyclone group at a certain pressure along a tangential direction through a feeding pump;
feeding the raw coal of 1-6 mm into the rotating drum of the hypergravity field separator corresponding to the underflow port of the grading hydrocyclone group at a certain pressure along a tangential direction through a feeding pump so that a material forms descending spiral flow along an inner wall at an upper part of the rotating drum and medium-density and high-density materials descend along outer spiral flow under the action of a centrifugal force to form upward inner spiral flow at an axis of the rotating drum due to a negative pressure, where the low-density material ascends along the inner spiral flow and is discharged through a floating object discharging port, the medium-density and high-density materials are accelerated by a high-speed rotor when descending to the bottom of the rotating drum along the outer spiral flow, the high-density material continues going downward along the inner wall under an action of an additional strong centrifugal force in a hypergravity field and is discharged through a sediment discharging port, and the medium-density material goes upward along the inner spiral flow and is discharged through a floating object discharging port; and
dehydrating a product by respectively conveying clean coal and gangue obtained by separation to dehydration treatment.
